(19) United States
(12) Patent Application Publication
(10) Pub. No.: US 2025/0086758 A1
(43) Pub. Date: Mar. 13, 2025

(54) IMAGE PROCESSING METHOD AND DEVICE

(71) Applicant: Lemon Inc., Grand Cayman (KY)

(72) Inventors: Yichun SHI, Los Angeles, CA (US); Xiao YANG, Los Angeles, CA (US); Xiaohui SHEN, Los Angeles, CA (US)

(21) Appl. No.: 18/728,042

(22) PCT Filed: Jan. 13, 2023
(86) PCT No.: PCT/SG2023/050026

§ 371 Date: Jul. 10, 2024

(30) Foreign Application Priority Data
Jan. 14, 2022 (CN) 202210045090.0

(51) Int. Cl. G06T 5/60; G06T 5/50

(52) U.S. Cl. CPC G06T 5/60; G06T 5/50; G06T 2207/20081; G06T 2207/20084

(57) ABSTRACT

The present disclosure provides an image processing method and device. The image processing method includes: performing, by an encoder and a first model, multiple iterations on an initial image to obtain a target image feature corresponding to the initial image; and performing, by a second model, image reconstruction based on the target image feature to obtain a reconstructed image of the initial image, both of the first model and the second model being neural networks for image reconstruction, wherein in the multiple iterations, an image feature extracted by the first model in the image reconstruction and an output image of the first model are feedback information for the encoder to assist the encoder in encoding the initial image.

### CROSS-REFERENCE TO RELATED APPLICATION

The present disclosure claims the priority to a Chinese Patent Application filed on Jan. 14, 2022, with application Ser. No. 20/221,0045090.0, entitled “Image Processing Method and Device”, and the entire content of which is incorporated by reference in this article.

### TECHNICAL FIELD

Embodiments of the present disclosure relate to the technical field of computers, in particular to an image processing method and device, a model determination method and device, an electronic device, a computer readable storage medium, a computer program product, and a computer program.

### BACKGROUND

With the development of the computer vision technology and the deep learning technology, an image generation model is capable of generating a lifelike image and has broad application prospects in the fields of image editing, video generation, etc.

In an image generation process, an original image is firstly mapped, by an encoder, to an image feature in a feature space, and the image feature is input to the image generation model for image reconstruction to obtain a new image. However, the quality of the image reconstructed in the above process needs to be improved.

### SUMMARY

Embodiments of the present disclosure provide an image processing method and device, a model determination method and device, an electronic device, a computer readable storage medium, a computer program product, and a computer program to solve the problem of improving image quality in image reconstruction.

In a first aspect, an embodiment of the present disclosure provides an image processing method, including:
performing, by an encoder and a first model, multiple iterations on an initial image to obtain a target image feature corresponding to the initial image; and
performing, by a second model, image reconstruction based on the target image feature to obtain a reconstructed image of the initial image, both of the first model and the second model being neural networks for image reconstruction,
wherein in the multiple iterations, an image feature extracted by the first model in the image reconstruction and an output image of the first model are feedback information for the encoder to assist the encoder in encoding the initial image.

In a second aspect, an embodiment of the present disclosure provides a model determination method, including:
obtaining a training image; and
performing, by an encoder and a first model, multiple iterations on the training image, and in the multiple iterations, adjusting a model parameter of the encoder based on a difference between an output image of the first model and the training image to obtain a trained encoder, the first model being a neural network for image reconstruction,
wherein in the multiple iterations, an image feature extracted by the first model in the image reconstruction and an output image of the first model are feedback information for the encoder to assist the encoder in encoding the training image.

In a third aspect, an embodiment of the present disclosure provides an image processing device, including:
an iterative processing unit, configured to perform, by an encoder and a first model, multiple iterations on an initial image to obtain a target image feature corresponding to the initial image; and
an image reconstruction unit, configured to perform, by a second model, image reconstruction based on the target image feature to obtain a reconstructed image of the initial image, both of the first model and the second model being neural networks for image reconstruction,
wherein in the multiple iterations, an image feature extracted by the first model in the image reconstruction and an output image of the first model are feedback information for the encoder to assist the encoder in encoding the initial image.

In a fourth aspect, an embodiment of the present disclosure provides a model determination device, including:
an obtaining unit, configured to obtain a training image; and
an iterative processing unit, configured to perform, by an encoder and a first model, multiple iterations on the training image, and in the multiple iterations, adjust a model parameter of the encoder based on a difference between an output image of the first model and the training image to obtain a trained encoder, the first model being a neural network for image reconstruction,
wherein in the multiple iterations, an image feature extracted by the first model in the image reconstruction and an output image of the first model are feedback information for the encoder to assist the encoder in encoding the training image.

In a fifth aspect, an embodiment of the present disclosure provides an electronic device, including: at least one processor and a memory,
the memory stores computer executable instructions; and
when the at least one processor executes the computer executable instructions stored in the memory, the at least one processor is caused to perform the image processing method as described in the first aspect and various possible designs of the first aspect, or perform the model determination method as described in the second aspect and various possible designs of the second aspect.

In a sixth aspect, an embodiment of the present disclosure provides a computer readable storage medium, the computer readable storage medium stores computer executable instructions, and when the computer executable instructions are executed by a processor, the image processing method as described in the first aspect and various possible designs of the first aspect, or the model determination method as described in the second aspect and various possible designs of the second aspect is implemented.

In a seventh aspect, according to one or more embodiments of the present disclosure, a computer program product is provided, the computer program product includes computer executable instructions, and when the computer executable instructions are executed by a processor, the image processing method as described in the first aspect and various possible designs of the first aspect, or the model determination method as described in the second aspect and various possible designs of the second aspect is implemented.

In an eighth aspect, according to one or more embodiments of the present disclosure, a computer program is provided, when the computer program is executed by a processor, the image processing method as described in the first aspect and various possible designs of the first aspect, or the model determination method as described in the second aspect and various possible designs of the second aspect is implemented.

According to the image processing method and device provided in the embodiments, multiple iterations are performed by the encoder and the first model on the initial image to obtain the target image feature corresponding to the initial image, and image reconstruction is performed by the second model based on the target image feature to obtain the reconstructed image of the initial image. In the multiple iterations, the image feature extracted by the first model in the image reconstruction and the output image of the first model are feedback information for the encoder to assist the encoder in encoding the initial image. Consequently, by performing the multiple iterations in the encoding processes and by using the image features and the output images obtained by the image reconstruction processes as the feedback information for the encoding processes in the multiple iterations, the encoding performance of the encoder is improved, which in turn improves the quality of the reconstructed image.

### BRIEF DESCRIPTION OF DRAWINGS

In order to more clearly illustrate the technical solutions in the embodiments of the present disclosure or prior art, the drawings that need to be used in the description of the embodiments or prior art will be briefly described in the following, and it will be obvious that the described drawings in the following are some embodiments of the present disclosure. For those skilled in the art, other drawings can be obtained according to these drawings without inventive work.

FIG. 1 is a schematic diagram of an application scenario applicable to an embodiment of the present disclosure;

FIG. 2 is a first flowchart of an image processing method provided in an embodiment of the present disclosure;

FIG. 3 is a flowchart of performing, by an encoder and a first model, an nth iteration on an initial image provided in an embodiment of the present disclosure;

FIG. 4a is a first diagram of a network structure example provided in an embodiment of the present disclosure;

FIG. 4b is a second diagram of a network structure example provided in an embodiment of the present disclosure;

FIG. 5 is a second flowchart of an image processing method provided in an embodiment of the present disclosure;

FIG. 6 is a flowchart of a model determination method provided in an embodiment of the present disclosure;

FIG. 7 is a flowchart of performing, by an encoder and a first model, an nth iteration on a training image provided in an embodiment of the present disclosure;

FIG. 8 is a structural block diagram of an image processing device provided in an embodiment of the present disclosure;

FIG. 9 is a structural block diagram of a model determination device provided in an embodiment of the present disclosure; and

FIG. 10 is a schematic diagram of a hardware structure of an electronic device provided in an embodiment of the present disclosure.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art, based on the embodiments of the present disclosure without creative efforts, should fall within the protection scope of the present disclosure.

Usually, in an image generation process, one real image is encoded to an input space of an image generation model, and image reconstruction is performed by the image generation model. There are two ways of encoding one real image to the input space of the image generation model. The first way is a way based on optimization: an input to the image generation model is optimized by a gradient descent method to increase the degree of similarity between an output and the input of the image generation model. The second way is a way based on training encoder: an encoder is trained, and an image is directly mapped to the input space of the image generation model by the trained encoder.

Major indicators for an encoding process are an encoding speed and image reconstruction performance. While the first way can achieve good image reconstruction performance, the encoding speed of the first way is lower than that of the second way. For the second way, the inventors have found that the image reconstruction performance of image reconstruction based on the second way has a large room for improvement.

To solve the above problems, the embodiments of the present disclosure provide an image processing method and device, multiple iterations are performed by an encoder and a first model on an initial image to obtain a target image feature corresponding to the initial image, and image reconstruction is performed by a second model based on the target image feature to obtain a reconstructed image of the initial image. Both of the first model and the second model are neural networks for image reconstruction. In the nth iteration process, the encoder performs the nth iteration on the initial image based on an image feature output by a network layer of the first model and an output image of the first model in nth image reconstruction.

As can be seen, according to the embodiments of the present disclosure, in the encoding process, in an aspect, encoding is performed for a plurality of times by means of iterative processing. In another aspect, the image feature output by the first model and the image output by the first model in the image reconstruction are used as feedback information to assist the encoder with the encoding process. Consequently, the encoding performance of the encoder is effectively improved, which in turns improves the image reconstruction performance and improves the quality of the reconstructed image.

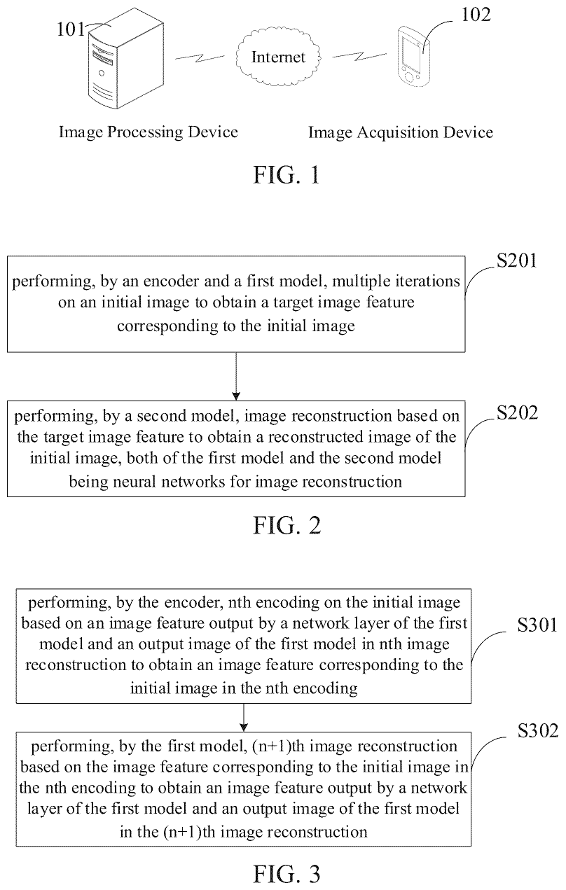

Referring to FIG. 1, FIG. 1 is a schematic diagram of an application scenario applicable to an embodiment of the present disclosure.

As shown in FIG. 1, in the application scenario, involved devices include an image processing device 101. The image processing device 101 may be a terminal or a server. In FIG. 1, the image processing device 101 is the server for example. On the image processing device 101, image encoding is performed by an encoder, and image reconstruction is performed by an image generation model.

Optionally, the devices involved in the application scenario further include an image acquisition device 102. The image acquisition device 102 may also be a terminal or a server. For example, the terminal acquires an image input by a user, or the terminal acquires an image in the current scene by a camera. For another example, the server acquires an image published on the Internet and allowed for use by the public from the Internet. In FIG. 1, the image acquisition device 102 is the terminal for example. The image acquisition device 102 transmits an acquired image to the image processing device 101, and the image processing device 101 performs image processing operations such as encoding and reconstruction on the image.

As an example, the user shoots an image or a video of a current scene by using a mobile phone. The mobile phone transmits the image or the video to the server, and the server performs encoding or reconstruction on the image, or multi-frame image in the video (e.g., some special effects may be added, or, the quality of the image or multi-frame image in the video is improved) to obtain a reconstructed image and furnishes the reconstructed image back to the user's mobile phone for displaying.

The terminal may be a personal digital assistant (PDA) device, a handheld device (e.g., a smart phone or a tablet computer), a computing device (e.g., a personal computer (PC)), a vehicular device, a wearable device (e.g., a smart watch or a smart bracelet), a smart home device (e.g., a smart display device), or the like. The server may be a distributed server, a centralized server, a cloud server, or the like.

The following provides a plurality of embodiments of the present disclosure. An executive main body of the plurality of embodiments of the present disclosure may be an electronic device, and the electronic device may be a terminal or a server.

FIG. 2 is a first flowchart of an image processing method provided in an embodiment of the present disclosure. As shown in FIG. 2, the image processing method includes the following steps.

S201: performing, by an encoder and a first model, multiple iterations on an initial image to obtain a target image feature corresponding to the initial image.

The initial image may be a human face image, an animal image, a vehicle image, or the like.

The first model is a neural network for image reconstruction. In an iterative processing process of the initial image, the encoder is configured to encode the initial image and output an image feature corresponding to the initial image, and the first model is used for performing image reconstruction on the image feature corresponding to the initial image to obtain image features output by a plurality of network layers and a reconstructed image output by an output layer (for ease of description, the reconstructed image output by the output layer of the first model is hereinafter referred to as an output image of the first model). The image features output by a plurality of network layers of the first model (i.e., image features extracted by the first model in the image reconstruction process) and the output image of the first model may be used as feedback information for the encoder to use in the process of encoding the initial image to assist the encoder with better encoding and improve the encoding performance.

In the present embodiment, in each iteration, the encoder encodes the initial image based on the feedback information from the first model, maps the initial image to a feature space corresponding to the first model to obtain an image feature corresponding to the initial image in the current iteration, and then outputs the image feature corresponding to the initial image in the current iteration from the first model for image reconstruction to obtain the feedback information from the first model and used for next encoding. Multiple iterations are performed in this way until a number of iterations is greater than or equal to a preset number threshold to obtain an image feature corresponding to the initial image obtained by the final encoding, i.e., the target image feature corresponding to the initial image. Consequently, by using the first model to provide the encoder with the feedback information and performing multiple iterations, the encoding performance of the encoder is improved and the accuracy of the image features obtained by encoding is improved, which in turn are conducive to improving the quality of the subsequent reconstructed image.

The feature space corresponding to the first model may be construed as an input space of the first model. For example, the input space has an own encoding mode, in the case where an input to the first model is a string of code, the initial image needs to be converted by the encoder to a string of code that conforms to the encoding mode.

S202: performing, by a second model, image reconstruction based on the target image feature to obtain a reconstructed image of the initial image, both of the first model and the second model being neural networks for image reconstruction.

In the present embodiment, after the target image feature corresponding to the initial image is obtained, the target image feature corresponding to the initial image may be input to the second model. The second model performs image reconstruction on the basis of the target image feature to obtain the reconstructed image of the initial image, thus completing the image reconstruction on the initial image.

The first model and the second model may be same models or different models.

Optionally, the first model and the second model are generative adversarial networks. Consequently, an image is generated by the generative adversarial networks and the quality of the reconstructed image is improved.

Optionally, in the case where the first model and the second model are generative adversarial networks, the first model and the second model are style-based architecture for GANs (StyleGAN) models or StyleGAN2 models. In the case where the first model and the second model are same models, both of the first model and the second model may be the StyleGAN models or the StyleGAN2 models.

Optionally, in the case where the first model and the second model are generative adversarial networks, the feature space corresponding to the first model is a latent space corresponding to the first model, and an image feature of the initial image obtained by the encoder is a latent code, and the target image feature corresponding to the initial image is a target latent code corresponding to the initial image. In this case, the image processing process includes: performing, by the encoder and the first model, multiple iterations on the initial image to obtain the target latent code corresponding to the initial image; and performing, by the second model, image reconstruction based on the target latent code to obtain the reconstructed image of the initial image.

In the embodiment of the present disclosure, encoding on the initial image is realized by means of the multiple iterations, and in the process of the multiple iterations, an image feature corresponding to the initial image obtained by encoding is used as an input to the first model. Image reconstruction is performed by the first model, and an image feature output by a network layer of the first model and an output image of the first model in the image reconstruction process are used as the feedback information for the encoding process to assist the encoder in encoding the initial image. Consequently, the encoding performance of the encoder is effectively improved. After the multiple iterations, image reconstruction is performed by the second model based on the target image features corresponding to the initial image obtained by final encoding, to obtain the reconstructed image of the initial image, which in turn improves the quality of the reconstructed image.

The process of the multiple iterations is described in detail below.

In some embodiments, FIG. 3 is a flowchart of performing, by an encoder and a first model, an nth iteration on an initial image provided in an embodiment of the present disclosure. As shown in FIG. 3, the nth iteration process of the initial image includes the following steps.

S301: performing, by the encoder, nth encoding on the initial image based on an image feature output by a network layer of the first model and an output image of the first model in nth image reconstruction to obtain an image feature corresponding to the initial image in the nth encoding.

S302: performing, by the first model, (n+1)th image reconstruction based on the image feature corresponding to the initial image in the nth encoding to obtain an image feature output by a network layer of the first model and an output image of the first model in the (n+1)th image reconstruction.

In particular, n is an integer greater than or equal to 1.

In the present embodiment, in the nth iteration, the image feature output by the network layer of the first model and the output image of the first model in nth image reconstruction are used as the feedback information for the encoding process, and the encoder performs the nth encoding on the initial image based on the feedback information to obtain the image feature corresponding to the initial image in the nth encoding. The image feature corresponding to the initial image in the nth encoding is input to the first model to perform the (n+1)th image reconstruction to obtain the image feature output by the network layer of the first model and the output image of the first model in the (n+1)th image reconstruction, which are used for the (n+1)th encoding of the initial image.

In an example, when n=1, i.e., in the process of the first iteration, since the first encoding has not been performed on the initial image by the encoder, an image feature of the initial image that may be used for the first model to perform the first image reconstruction is not obtained. To ensure that there is corresponding feedback information for use in the first encoding of the initial image, an initial image feature may be determined, and the first image reconstruction is performed by the first model based on the initial image feature to obtain an image feature output by a network layer of the first model and an output image of the first model in the first image reconstruction. Consequently, the image feature output by the network layer of the first model and the output image of the first model in the first image reconstruction may be used for the first encoding of the initial image.

Optionally, the initial image feature is determined randomly or a preset initial image feature is employed.

Optionally, the initial image feature is determined based on a probability distribution of the feature space corresponding to the first model.

The feature space corresponding to the first model conforms to a certain probability distribution, e.g., Gaussian distribution.

Specifically, in a way, the initial image feature may be obtained by random sampling in the feature space based on the probability distribution of the feature space corresponding to the first model. In another way, an average image feature in the feature space may be determined based on the probability distribution of the feature space corresponding to the first mode, and the initial image feature is determined as the average image feature.

Optionally, when n=1, in addition to the above ways, the encoder may perform the first encoding on the initial image without the feedback information. In this case, when n is greater than 1, the nth iteration process of the initial image includes: performing, by the encoder, the nth encoding on the initial image based on an image feature output by a network layer of the first model and an output image of the first model in (n−1)th image reconstruction to obtain an image feature corresponding to the initial image in the nth encoding; and performing, by the first model, nth image reconstruction based on the image feature corresponding to the initial image in the nth encoding to obtain an image feature output by a network layer of the first model and an output image of the first model in the nth image reconstruction.

In an example, a possible implementation of S301 includes: inputting the initial image, and the output image of the first model in the nth image construction to the encoder; and encoding, in a network layer of the encoder, an image feature output by a previous network layer, and the image feature output by a corresponding network layer of the first model in the nth image reconstruction, to obtain an image feature output by the encoder, i.e., the image feature corresponding to the initial image in the nth encoding. Consequently, it is realized that the output image of the first model and the image feature output by the network layer of the first model are applied to the encoding process of the initial image, and the encoding performance of the encoder is improved.

Specifically, in the nth iteration, the initial image and the output image of the first model in the nth image reconstruction are merged, and the merged image is input to an input layer of the encoder. For a network layer located in the middle of the encoder, the image feature output by a previous network layer, and the image feature output by the corresponding network layer of the first model in the nth image reconstruction are used as input data to the network layer, and the input data is encoded at this network layer. In this way, after encoding by a plurality of network layers, the image feature output by the encoder is obtained.

Optionally, the way of merging the initial image and the output image of the first model in the nth image reconstruction includes: in an RGB space, splicing pixels in the initial image with pixels at corresponding positions of the output image of the first model in the nth image reconstruction to obtain an input image to the encoder.

For example, each pixel of the initial image corresponds to 1 R, 1 G, and 1 B, and each pixel of the output image of the first image also corresponds to 1 R, 1 G, and 1 B, and each pixel of the image obtained by merging the initial image and the output image of the first model corresponds to 2 Rs, 2 Gs, and 2 Bs.

A relationship between the encoder and the first model is described below by some embodiments.

In some embodiments, network layers of a same feature scale of the first model and the encoder are in one-to-one correspondence with each other. In other words, network layers in the encoder are in one-to-one correspondence with network layers of a same feature scale of the first model. In this case, the encoding, in the network layer of the encoder, the image feature output by the previous network layer, and the image feature output by the corresponding network layer of the first model in the nth image reconstruction, to obtain the image feature output by the encoder includes: encoding a first image feature and a second image feature in a current network layer of the encoder, where the first image feature is an image feature output by a previous network layer of the current network layer, and the second image feature is an image feature output by the network layer of the same feature scale with the previous network layer of the first model in the nth image reconstruction.

The feature scale is also referred to as a feature map size.

Specifically, in the image reconstruction process, an image feature of each feature scale of the first model is saved. In the encoding process, the image feature of each feature scale of the first model is merged with an image feature of the same feature scale in the encoder and input to next network layer of the encoder. Consequently, the image feature output by the network layer of the first model is used for the encoding process of the encoder, thereby improving the richness of features in the encoding process and improving the encoding performance.

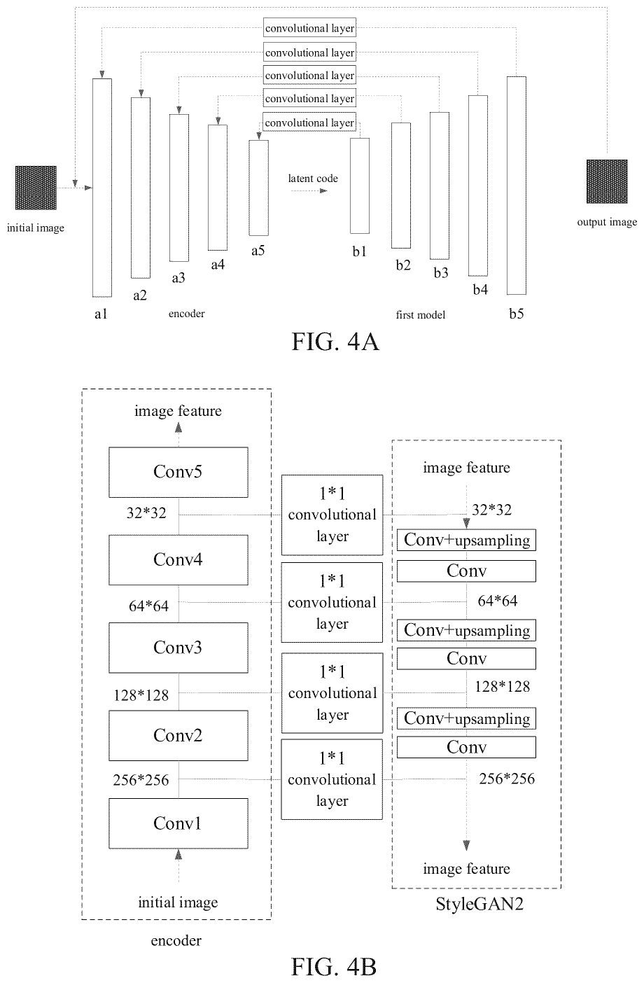

For example, FIG. 4a is a first diagram of a network structure example provided in an embodiment of the present disclosure. As shown in FIG. 4a, the output image of the first model is used as the feedback information for the input layer of the encoder and input together with the initial image to the encoder. The image features output by the plurality of network layers of the first model are used as the feedback information for the middle network layer of the encoder and input together with the image feature output by the network layer of the same feature scale in the encoder to next network layer. In one iteration process, the initial image and the output image of the first model are input to the encoder. In a plurality of network layers of the encoder, the image features output by the network layers of the same feature scale of the previous network layer and the first model are input to the current network layer. After encoding by the plurality of network layers, a latent code output by the encoder is obtained. The latent code is input to the first mode and image reconstruction is performed by the first model. In the image reconstruction process, the image features output by the network layers of various feature scales of the first model and the output images of the first model are saved for use in next encoding of the initial image. In this way, the latent code finally output by the encoder, i.e., the target image feature of the initial image, is obtained after the multiple iterations.

Optionally, in the first model and the encoder, two network layers of the same feature scale may have different numbers of channels. Therefore, a convolutional layer is connected between the network layers of the same feature scale of the first model and the encoder, and a number of channels of the network layer of the first model is converted into a number of channels of the network layer of the same feature scale in the encoder by the convolutional layer, so that the image feature output by the network layer of the first model can be successfully input to the corresponding network layer of the encoder.

For example, as shown in FIG. 4A, in the encoder and the first model, network layer a1 and network b5, network layer a2 and network b4, network layer a3 and network b3, network layer a4 and network b2, and network layer a5 and network b1 are convolutional layers of the same feature scales, respectively. A convolutional layer is connected between these convolutional layers, realizing a unified number of channels between the network layers of the same feature scale.

For example, the number of channels of the network layer al in the encoder is 64 and the number of channels of the network layer b5 in the second model is 128. In case of different numbers of channels, the image feature output by the network layer b5 cannot input to the network layer a1. Therefore, 128 image features output by the network may be converted by the convolutional layer into 64 image features, and the converted 64 image features are then input to the network layer al.

In some embodiments, when the first model is the StyleGAN2 model, since there are a plurality of network layers of a same feature scale in the StyleGAN2 model, the network in the encoder corresponds to one of the network layers of the same feature scale in the StyleGAN2model. It is realized that the network layers of different feature scales in the StyleGAN2 model feed back image features to the encoder to assist the encoder with the encoding process and improve the encoding performance.

Optionally, a convolutional layer is connected between the network layer of the encoder and one of the network layers of the same feature scale in the StyleGAN2 model so that the image feature output by the network layer of the StyleGAN2 model can be successfully input to the corresponding network layer of the encoder.

FIG. 4b is a second diagram of a network structure example provided in an embodiment of the present disclosure. In FIG. 4b, the encoder includes a plurality of convolutional layers: Conv1, Conv2, Conv3, Conv4, and Conv5. The feature scales of Conv1, Conv2, Conv3, and Conv4 are 256*256, 128*128, 64*64, and 32*32, respectively. The StyleGAN2 model includes the convolutional layers under the plurality of feature scales of 256*256, 128*128, 64*64, and 32*32. The convolutional layer under each feature scale includes one convolutional layer Conv and a “Conv+upsampling” layer located above the convolutional layer. Between the encoder and the StyleGAN2 model, for each feature scale, the “Conv+upsampling” layer in the StyleGAN2 model is connected to the convolutional layer of the same feature scale in the encoder through 1*1 convolutional layer.

As shown in FIG. 4b, the initial image is input to the Conv1 of the encoder for encoding to obtain an image feature of size 256*256 output by Conv1, and the image feature is merged with the image feature of size 256*256 from StyleGAN2 and then input to Conv2 for encoding. In this way, after encoding by layers of networks, the image feature output by the encoder is obtained. In the decoder, an image feature is input to a network layer in StyleGAN2 for image reconstruction.

In the image reconstruction process, the StyleGAN2 feeds back the image features, obtained by the network layers under a plurality of feature scales, to the network layers of the same feature scales of the encoder for use in next encoding of the initial image.

The encoder, the first model, and the second model provided in the above embodiments, and the image processing method provided in the above embodiments may be applied to video generation in addition to image reconstruction. The following provides embodiments of applying the above models and the method to video generation.

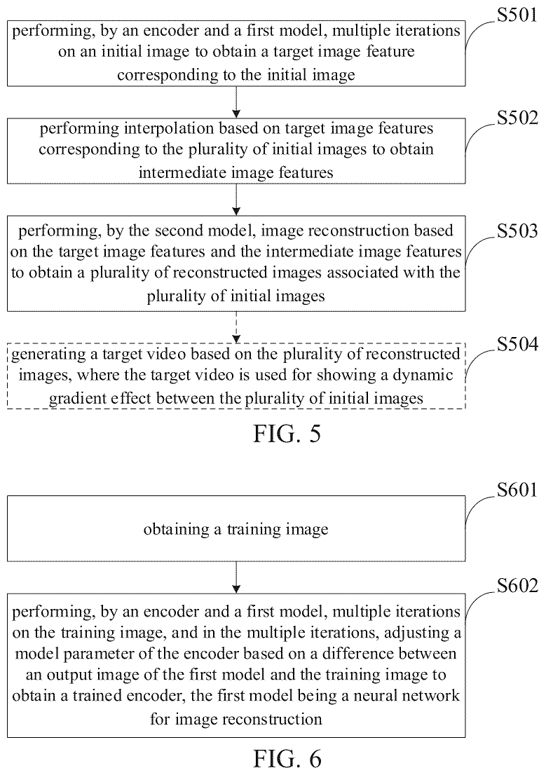

FIG. 5 is a second flowchart of an image processing method provided in an embodiment of the present disclosure. As shown in FIG. 5, the image processing method includes the following steps.

S501: performing, by an encoder and a first model, multiple iterations on an initial image to obtain a target image feature corresponding to the initial image.

There are a plurality of initial images.

The implementation principle of S501 and the technical effects may be as described in the foregoing embodiments, which will not be described redundantly.

S502: performing interpolation based on target image features corresponding to the plurality of initial images to obtain intermediate image features.

In the present embodiment, linear interpolation or nonlinear interpolation may be performed by utilizing the target image features corresponding to the plurality of initial images to obtain an interpolation function. The interpolation function may be typically expressed as one interpolation straight line or one interpolation curve. Sampling is performed on the interpolation straight line or the interpolation curve to obtain a plurality of intermediate image features.

The way of sampling may be, e.g., random sampling or sampling at fixed intervals.

S503: performing, by the second model, image reconstruction based on the target image features and the intermediate image features to obtain a plurality of reconstructed images associated with the plurality of initial images.

In the present embodiment, the target image features and the intermediate image features are separately input to the second model for image reconstruction to obtain the reconstructed images corresponding to the target image features and the reconstructed images corresponding to the intermediate image features, i.e., a plurality of reconstructed images associated with the plurality of initial images. Since the intermediate image features are obtained based on the target image features and are highly similar to the target image features, in addition to image reconstruction on the initial images, other images highly similar to the initial images are also generated in the present embodiment.

In some embodiments, as shown in FIG. 5, the image processing method further includes the following step. S504: generating a target video based on the plurality of reconstructed images, where the target video is used for showing a dynamic gradient effect between the plurality of initial images.

In the present embodiment, after the reconstructed images corresponding to the target image features and the reconstructed images corresponding to the intermediate image features are obtained, the plurality of reconstructed images are used as video frames to create the target video. In the process of creating the target video, the positions of the plurality of reconstructed images in the target video may be determined according to a distribution order of the target image features and the intermediate image features in the interpolation straight line or the interpolation curve, such that the target video is capable of showing the dynamic gradient effect between the initial images.

Optionally, the number of the initial images is 2. When creating the target video, the reconstructed image of one initial image may be determined as a first image of the target video and the reconstructed image of the other initial image as the last image of the target video, and the reconstructed images corresponding to the intermediate image features are determined as the images in the middle of the target video. In this way, the target video may show a dynamic gradient effect from one initial image to the other initial image. Consequently, the interestingness of video showing is improved on the one hand; and on the other hand, the quality of the multi-frame image in the video is improved by improving the image reconstruction performance of the encoder, which in turn improves the video quality.

The application process of the encoder, the first model, and the second model are described above by means of embodiments, and it is necessary to train the encoder in advance to improve the encoding performance of the encoder. The following provides an embodiment related to the training process of the encoder.

FIG. 6 is a flowchart of a model determination method provided in an embodiment of the present disclosure. As shown in FIG. 6, the model determination method includes the following steps.

S601: obtaining a training image.

S602: performing, by an encoder and a first model, multiple iterations on the training image, and in the multiple iterations, adjusting a model parameter of the encoder based on a difference between an output image of the first model and the training image to obtain a trained encoder, the first model being a neural network for image reconstruction.

In the present embodiment, in each iteration of the training image, the training image is encoded by the encoder based on feedback information from the first model to obtain an image feature of the training image. The image feature of the training image is input to the first model to obtain image features output by a plurality of network layers of the first model and an output image of the first model. On the one hand, the image features output by the plurality of network layers of the first model (i.e., the image features extracted by the first model in image reconstruction) and the output image of the first model are used as feedback information for use in next encoding of the training image; and on the other hand, the difference between the output image of the first model and the training image is determined, and the model parameter of the encoder is adjusted based on the difference to obtain the trained encoder. In this way, parameter adjustment of the encoder is performed after each iteration until a number of iterations is greater than a number threshold or until the difference between the output image of the first model and the training image is less than a difference threshold, thereby obtaining the trained encoder.

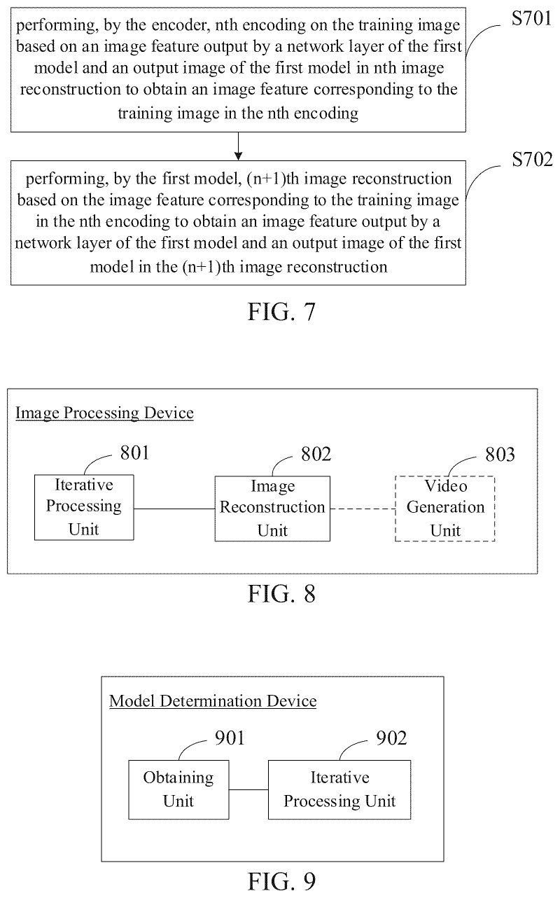

In some embodiments, FIG. 7 is a flowchart of performing, by an encoder and a first model, an nth iteration on a training image provided in an embodiment of the present disclosure. As shown in FIG. 7, the nth iteration process of the training image includes the following steps.

S701: performing, by the encoder, nth encoding on the training image based on an image feature output by a network layer of the first model and an output image of the first model in nth image reconstruction to obtain an image feature corresponding to the training image in the nth encoding.

S702: performing, by the first model, (n+1)th image reconstruction based on the image feature corresponding to the training image in the nth encoding to obtain an image feature output by a network layer of the first model and an output image of the first model in the (n+1)th image reconstruction.

In particular, n is greater than or equal to 1.

In some embodiments, the nth iteration of the training image specifically includes: inputting the training image, and the output image of the first model in the nth image construction to the encoder; encoding, in a network layer of the encoder, an image feature output by a previous network layer, and the image feature output by a corresponding network layer of the first model in the nth image reconstruction, to obtain an image feature corresponding to the training image in the nth encoding output by the encoder; inputting the image feature corresponding to the initial image in the nth encoding to the first model to obtain the image feature output by the network layer of the first model and the output image of the first model in the (n+1)th image reconstruction; and adjusting a model parameter of the encoder based on a difference between the output image of the first model in the (n+1)th image reconstruction and the training image to obtain the encoder after the nth training.

Regarding the aforementioned iterative processing process, please refer to the iterative processing process of the initial image in the foregoing embodiments. The relationship between the first model and the encoder, as well as the type of the first model may also be as described in the foregoing embodiments, which will not be described redundantly here.

In some embodiments, the difference between the output image of the first model and the training image is a similarity error of the output image of the first model and the training image. Consequently, in the training process, the similarity of the output image of the first model and the training image is improved by adjusting a parameter of the encoder, thereby improving the image reconstruction quality.

Corresponding to the image processing method of the aforementioned embodiment, FIG. 8 is a structural block diagram of an image processing device provided in an embodiment of the present disclosure. For ease of description, only the parts related to this embodiment of the present disclosure are illustrated. With reference to FIG. 8, the image processing device includes an iterative processing unit 801 and an image reconstruction unit 802.

The iterative processing unit 801 is configured to perform, by an encoder and a first model, multiple iterations on an initial image to obtain a target image feature corresponding to the initial image.

The image reconstruction unit 802 is configured to perform, by a second model, image reconstruction based on the target image feature to obtain a reconstructed image of the initial image, where both of the first model and the second model are neural networks for image reconstruction.

In the multiple iterations, the image feature extracted by the first model in the image reconstruction and the output image of the first model are feedback information for the encoder to assist the encoder in encoding the initial image.

In some embodiments, in the nth iteration process of the initial image, the iterative processing unit 801 is configured to: perform, by the encoder, nth encoding on the initial image based on an image feature output by a network layer of the first model and an output image of the first model in nth image reconstruction to obtain an image feature corresponding to the initial image in the nth encoding, n being greater than or equal to 1; and perform, by the first model, (n+1)th image reconstruction based on the image feature corresponding to the initial image in the nth encoding to obtain an image feature output by a network layer of the first model and an output image of the first model in the (n+1)th image reconstruction.

In some embodiments, the iterative processing unit 801 is further configured to: input the initial image, and the output image of the first model in the nth image construction to the encoder; and encode, in a network layer of the encoder, an image feature output by a previous network layer, and the image feature output by a corresponding network layer of the first model in the nth image reconstruction, to obtain the image feature corresponding to the initial image in the nth encoding output by the encoder.

In some embodiments, network layers of a same feature scale of the first model and the encoder are in one-to-one correspondence with each other.

In some embodiments, a convolutional layer is connected between the network layers of the same feature scale of the first model and the encoder, and a number of channels of the network layer of the first model is converted into a number of channels of the network layer of the same feature scale in the encoder by the convolutional layer.

In some embodiments, the iterative processing unit 801 is further configured to: determine an initial image feature; and perform, by the first model, image reconstruction based on the initial image feature to obtain an image feature output by a network layer of the first model and an output image of the first model in the first image reconstruction.

In some embodiments, the iterative processing unit 801 is further configured to: determine the initial image feature based on a probability distribution of a feature space corresponding to the first model.

In some embodiments, there are a plurality of initial images. The image reconstruction unit 802 is further configured to: perform interpolation based on the target image features corresponding to the plurality of initial images to obtain intermediate image features; and perform, by the second model, image reconstruction based on the target image features and the intermediate image features to obtain a plurality of reconstructed images associated with the plurality of initial images.

In some embodiments, the image processing device further includes:

a video generation unit 803, configured to generate a target video based on the plurality of reconstructed images, where the target video is used for showing a dynamic gradient effect between plurality of initial images.

In some embodiments, the first model is a StyleGAN model or a StyleGAN2 model and the second model is a StyleGAN model or a StyleGAN2 model.

The image processing device provided in the present embodiment may be configured to perform the technical solutions of the aforementioned embodiments related to the image processing method, and may follow similar implementation principles and have similar technical effects thereto, which will not be redundantly described in the present embodiment.

Corresponding to the model determination method of the aforementioned embodiments, FIG. 9 is a structural block diagram of a model determination device provided in an embodiment of the present disclosure. For ease of description, only the parts related to this embodiment of the present disclosure are illustrated. With reference to FIG. 9, the model determination device includes an obtaining unit 901 and an iterative processing unit 902.

The obtaining unit 901 is configured to obtain a training image.

The iterative processing unit 902 is configured to perform, by an encoder and a first model, multiple iterations on the training image, and in the multiple iterations, adjust a model parameter of the encoder based on a difference between an output image of the first model and the training image to obtain a trained encoder, where the first model is a neural network for image reconstruction.

In the multiple iterations, the image feature extracted by the first model in the image reconstruction and the output image of the first model are feedback information for the encoder to assist the encoder in encoding the training image.

In some embodiments, the nth iteration of the training image includes:

performing, by the encoder, nth encoding on the training image based on an image feature output by a network layer of the first model and an output image of the first model in nth image reconstruction to obtain an image feature corresponding to the training image in the nth encoding, n being greater than or equal to 1; and

performing, by the first model, (n+1)th image reconstruction based on the image feature corresponding to the training image in the nth encoding to obtain an image feature output by a network layer of the first model and an output image of the first model in the (n+1)th image reconstruction.

In some embodiments, the iterative processing unit 902 is further configured to: input the training image, and the output image of the first model in the nth image construction to the encoder; encode, in a network layer of the encoder, an image feature output by a previous network layer and the image feature output by a corresponding network layer of the first model in the nth image reconstruction, to obtain an image feature corresponding to the training image in the nth encoding output by the encoder; input the image feature corresponding to the initial image in the nth encoding to the first model to obtain the image feature output by the network layer of the first model and the output image of the first model in the (n+1)th image reconstruction; and adjust a model parameter of the encoder based on a difference between the output image of the first model in the (n+1)th image reconstruction and the training image to obtain the encoder after the nth training.

In some embodiments, network layers of a same feature scale of the first model and the encoder are in one-to-one correspondence with each other.

In some embodiments, a convolutional layer is connected between the network layers of the same feature scale of the first model and the encoder, and a number of channels of the network layer of the first model is converted into a number of channels of the network layer of the same feature scale in the encoder by the convolutional layer.

In some embodiments, the iterative processing unit 902 is further configured to: determine an initial image feature; and perform, by the first model, image reconstruction based on the initial image feature to obtain an image feature output by a network layer of the first model and an output image of the first model in the first image reconstruction.

In some embodiments, the iterative processing unit 902 is further configured to: determine the initial image feature based on a probability distribution of a feature space corresponding to the first model.

In some embodiments, the first model is a StyleGAN model or a StyleGAN2 model and the second model is a StyleGAN model or a StyleGAN2 model.

The model determination device provided in the present embodiment may be configured to perform the technical solutions of the aforementioned embodiments related to the model determination method, and may follow similar implementation principles and have similar technical effects thereto, which will not be redundantly described in the present embodiment.

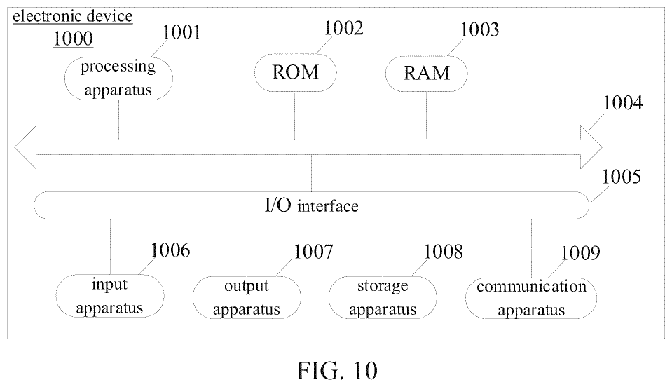

Referring to FIG. 10, FIG. 10 illustrates a schematic structural diagram of an electronic device 1000 suitable for implementing some embodiments of the present disclosure. The electronic device 1000 may be a terminal device or a server. The terminal device may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 10 is merely an example, and should not pose any limitation to the functions and the range of use of the embodiments of the present disclosure.

As illustrated in FIG. 10, the electronic device 1000 may include a processing apparatus 1001 (e.g., a central processing unit, a graphics processing unit, etc.), which can perform various suitable actions and processing according to a program stored in a read only memory (ROM) 1002 or a program loaded from a storage apparatus 1008 into a random access memory (RAM) 1003. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the electronic device 1000 to be in wireless or wired communication with other devices to exchange data. While FIG. 10 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a computer-readable medium. The computer program includes program codes for performing the methods shown in the flowcharts. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to implement the method in the above embodiment.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances, for example, an obtaining unit may also be described as “a unit for obtaining a target audio”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In a first aspect, according to one or more embodiments of the present disclosure, an image processing method is provided, including: performing, by an encoder and a first model, multiple iterations on an initial image to obtain a target image feature corresponding to the initial image; and performing, by a second model, image reconstruction based on the target image feature to obtain a reconstructed image of the initial image, both of the first model and the second model being neural networks for image reconstruction. In the multiple iterations, an image feature extracted by the first model in the image reconstruction and an output image of the first model are feedback information for the encoder to assist the encoder in encoding the initial image.

According to one or more embodiments of the present disclosure, an nth iteration on the initial image includes: performing, by the encoder, nth encoding on the initial image based on an image feature output by a network layer of the first model and an output image of the first model in nth image reconstruction to obtain an image feature corresponding to the initial image in the nth encoding, n being greater than or equal to 1; and performing, by the first model, (n+1)th image reconstruction based on the image feature corresponding to the initial image in the nth encoding to obtain an image feature output by a network layer of the first model and an output image of the first model in the (n+1)th image reconstruction.

According to one or more embodiments of the present disclosure, the performing, by the encoder, nth encoding on the initial image based on the image feature output by the network layer of the first model and the output image of the first model in nth image reconstruction to obtain the image feature corresponding to the initial image in the nth encoding includes: inputting the initial image, and the output image of the first model in the nth image reconstruction to the encoder; and encoding, in a network layer of the encoder, an image feature output by a previous network layer, and the image feature output by a corresponding network layer of the first model in the nth image reconstruction, to obtain the image feature corresponding to the initial image in the nth encoding output by the encoder.

According to one or more embodiments of the present disclosure, network layers of a same feature scale of the first model and the encoder are in one-to-one correspondence with each other.

According to one or more embodiments of the present disclosure, a convolutional layer is connected between network layers of a same feature scale of the first model and the encoder, and a number of channels of the network layer of the first model is converted into a number of channels of the network layer of the same feature scale in the encoder by the convolutional layer.

According to one or more embodiments of the present disclosure, before the performing multiple iterations on the initial image, further including: determining an initial image feature; and performing, by the first model, image reconstruction based on the initial image feature to obtain an image feature output by a network layer of the first model and an output image of the first model in the first image reconstruction.

According to one or more embodiments of the present disclosure, the determining the initial image feature includes: determining the initial image feature based on a probability distribution of a feature space corresponding to the first model.

According to one or more embodiments of the present disclosure, when there are a plurality of initial images, the performing, by the second model, image reconstruction based on the target image feature to obtain the reconstructed image of the initial image includes: performing interpolation based on target image features corresponding to the plurality of initial images to obtain intermediate image features; and performing, by the second model, image reconstruction based on the target image features and the intermediate image features to obtain a plurality of reconstructed images associated with the plurality of initial images.

According to one or more embodiments of the present disclosure, after the performing, by the second model, image reconstruction based on the target image features and the intermediate image features to obtain the plurality of reconstructed images associated with the plurality of initial images, further including: generating a target video based on the plurality of reconstructed images, the target video being used for showing a dynamic gradient effect between the plurality of initial images.

According to one or more embodiments of the present disclosure, the first model is a StyleGAN model or a StyleGAN2 model and the second model is a StyleGAN model or a StyleGAN2 model.

In a second aspect, according to one or more embodiments of the present disclosure, a model determination method is provided, including: obtaining a training image; and performing, by an encoder and a first model, multiple iterations on the training image, and in the multiple iterations, adjusting a model parameter of the encoder based on a difference between an output image of the first model and the training image to obtain a trained encoder, the first model being a neural network for image reconstruction. In the multiple iterations, an image feature extracted by the first model in the image reconstruction and an output image of the first model are feedback information for the encoder to assist the encoder in encoding the training image.

According to one or more embodiments of the present disclosure, an nth iteration on the training image includes: performing, by the encoder, nth encoding on the training image based on an image feature output by a network layer of the first model and an output image of the first model in nth image reconstruction to obtain an image feature corresponding to the training image in the nth encoding, n being greater than or equal to 1; and performing, by the first model, (n+1)th image reconstruction based on the image feature corresponding to the training image in the nth encoding to obtain an image feature output by a network layer of the first model and an output image of the first model in the (n+1)th image reconstruction.

In a third aspect, an embodiment of the present disclosure provides an image processing device, including: an iterative processing unit, configured to perform, by an encoder and a first model, multiple iterations on an initial image to obtain a target image feature corresponding to the initial image; and an image reconstruction unit, configured to perform, by a second model, image reconstruction based on the target image feature to obtain a reconstructed image of the initial image, both of the first model and the second model being neural networks for image reconstruction. In the multiple iterations, an image feature extracted by the first model in the image reconstruction and an output image of the first model are feedback information for the encoder to assist the encoder in encoding the initial image.

In a fourth aspect, an embodiment of the present disclosure provides a model determination device, including: an obtaining unit, configured to obtain a training image; and an iterative processing unit, configured to perform, by an encoder and a first model, multiple iterations on the training image, and in the multiple iterations, adjust a model parameter of the encoder based on a difference between an output image of the first model and the training image to obtain a trained encoder, the first model being a neural network for image reconstruction. In the multiple iterations, an image feature extracted by the first model in the image reconstruction and an output image of the first model are feedback information for the encoder to assist the encoder in encoding the training image.

In a fifth aspect, an embodiment of the present disclosure provides an electronic device, including: at least one processor and a memory, the memory stores computer executable instructions; and when the at least one processor executes the computer executable instructions stored in the memory, the at least one processor is caused to perform the image processing method as described in the first aspect and various possible designs of the first aspect, or perform the model determination method as described in the second aspect and various possible designs of the second aspect.

In a sixth aspect, an embodiment of the present disclosure provides a computer readable storage medium, the computer readable storage medium stores computer executable instructions, and when the computer executable instructions are executed by a processor, the image processing method as described in the first aspect and various possible designs of the first aspect, or the model determination method as described in the second aspect and various possible designs of the second aspect is implemented.

In a seventh aspect, according to one or more embodiments of the present disclosure, a computer program product is provided, the computer program product includes computer executable instructions, and when the computer executable instructions are executed by a processor, the image processing method as described in the first aspect and various possible designs of the first aspect, or the model determination method as described in the second aspect and various possible designs of the second aspect is implemented.

In an eighth aspect, according to one or more embodiments of the present disclosure, a computer program is provided, when the computer program is executed by a processor, the image processing method as described in the first aspect and various possible designs of the first aspect, or the model determination method as described in the second aspect and various possible designs of the second aspect is implemented.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

What is claimed is:

1. An image processing method, comprising:
performing, by an encoder and a first model, multiple iterations on an initial image to obtain a target image feature corresponding to the initial image; and
performing, by a second model, image reconstruction based on the target image feature to obtain a reconstructed image of the initial image, both of the first model and the second model being neural networks for image reconstruction,
wherein in the multiple iterations, an image feature extracted by the first model in the image reconstruction and an output image of the first model are feedback information for the encoder to assist the encoder in encoding the initial image.

2. The image processing method according to claim 1, wherein an nth iteration on the initial image comprises:
performing, by the encoder, nth encoding on the initial image based on an image feature output by a network layer of the first model and an output image of the first model in nth image reconstruction to obtain an image feature corresponding to the initial image in the nth encoding, n being greater than or equal to 1; and
performing, by the first model, (n+1)th image reconstruction based on the image feature corresponding to the initial image in the nth encoding to obtain an image feature output by a network layer of the first model and an output image of the first model in the (n+1)th image reconstruction.

3. The image processing method according to claim 2, wherein the performing, by the encoder, nth encoding on the initial image based on the image feature output by the network layer of the first model and the output image of the first model in nth image reconstruction to obtain the image feature corresponding to the initial image in the nth encoding comprises:
inputting the initial image, and the output image of the first model in the nth image reconstruction to the encoder; and
encoding, in a network layer of the encoder, an image feature output by a previous network layer, and the image feature output by a corresponding network layer of the first model in the nth image reconstruction, to obtain the image feature corresponding to the initial image in the nth encoding output by the encoder.

4. The image processing method according to claim 3, wherein network layers of a same feature scale of the first model and the encoder are in one-to-one correspondence with each other.

5. The image processing method according to claim 3, wherein a convolutional layer is connected between network layers of a same feature scale of the first model and the encoder, and a number of channels of the network layer of the first model is converted into a number of channels of the network layer of the same feature scale in the encoder by the convolutional layer.

6. The image processing method according to claim 2, before the performing multiple iterations on the initial image, further comprising:
determining an initial image feature; and
performing, by the first model, image reconstruction based on the initial image feature to obtain an image feature output by a network layer of the first model and an output image of the first model in the first image reconstruction.

7. The image processing method according to claim 6, wherein the determining the initial image feature comprises:
determining the initial image feature based on a probability distribution of a feature space corresponding to the first model.

8. The image processing method according to claim 1, wherein, when there are a plurality of initial images, the performing, by the second model, image reconstruction based on the target image feature to obtain the reconstructed image of the initial image comprises:
performing interpolation based on target image features corresponding to the plurality of initial images to obtain intermediate image features; and
performing, by the second model, image reconstruction based on the target image features and the intermediate image features to obtain a plurality of reconstructed images associated with the plurality of initial images.

9. The image processing method according to claim 8, after the performing, by the second model, image reconstruction based on the target image features and the intermediate image features to obtain the plurality of reconstructed images associated with the plurality of initial images, further comprising:
generating a target video based on the plurality of reconstructed images, wherein the target video is used for showing a dynamic gradient effect between the plurality of initial images.

10. The image processing method according to claim 1, wherein the first model is a StyleGAN model or a StyleGAN2 model and the second model is a StyleGAN model or a StyleGAN2 model.

11. A model determination method, comprising:
obtaining a training image; and
performing, by an encoder and a first model, multiple iterations on the training image, and in the multiple iterations, adjusting a model parameter of the encoder based on a difference between an output image of the first model and the training image to obtain a trained encoder, the first model being a neural network for image reconstruction,
wherein in the multiple iterations, an image feature extracted by the first model in the image reconstruction and an output image of the first model are feedback information for the encoder to assist the encoder in encoding the training image.

12. The model determination method according to claim 11, wherein an nth iteration on the training image comprises:
performing, by the encoder, nth encoding on the training image based on an image feature output by a network layer of the first model and an output image of the first model in nth image reconstruction to obtain an image feature corresponding to the training image in the nth encoding, n being greater than or equal to 1; and
performing, by the first model, (n+1)th image reconstruction based on the image feature corresponding to the training image in the nth encoding to obtain an image feature output by a network layer of the first model and an output image of the first model in the (n+1)th image reconstruction.

13. An image processing device, comprising:
an iterative processing unit, configured to perform, by an encoder and a first model, multiple iterations on an initial image to obtain a target image feature corresponding to the initial image; and
an image reconstruction unit, configured to perform, by a second model, image reconstruction based on the target image feature to obtain a reconstructed image of the initial image, both of the first model and the second model being neural networks for image reconstruction,
wherein in the multiple iterations, an image feature extracted by the first model in the image reconstruction and an output image of the first model are feedback information for the encoder to assist the encoder in encoding the initial image.

14. (canceled)

15. An electronic device, comprising: at least one processor and a memory,
wherein the memory stores computer executable instructions; and
when the at least one processor executes the computer executable instructions stored in the memory, the at least one processor is caused to perform the image processing method according to claim 1.

16. A non-transitory computer readable storage medium, wherein the computer readable storage medium stores computer executable instructions, and when the computer executable instructions are executed by a processor, the image processing method according claim 1 is implemented.

17. A computer program product, wherein the computer program product comprises computer executable instructions, and when the computer executable instructions are executed by a processor, the image processing method according to claim 1 is implemented.

18. A computer program, wherein when the computer program is executed by a processor, the image processing method according to claim 1 is implemented.

19. An electronic device, comprising: at least one processor and a memory,
wherein the memory stores computer executable instructions; and
when the at least one processor executes the computer executable instructions stored in the memory, the at least one processor is caused to perform the model determination method according to claim 11.

20. A non-transitory computer readable storage medium, wherein the computer readable storage medium stores computer executable instructions, and when the computer executable instructions are executed by a processor, the model determination method according to claim 11 is implemented.

21. A computer program product, wherein the computer program product comprises computer executable instructions, and when the computer executable instructions are executed by a processor, the model determination method according to claim 11 is implemented.
